(19) United States
(12) Patent Application Publication
(10) Pub. No.: US 2010/0167906 A1
(43) Pub. Date: Jul. 1, 2010

(54) PROCESS OF MAKING A DENSE SYNTHETIC SILICA GLASS, A MUFFLE FURNACE FOR PERFORMING THE PROCESS, AND SILICA GLASS OBTAINED FROM SAID PROCESS

(76) Inventors: Lars Ortmann, Jena (DE); Rolf Martin, Jena (DE); Ulrich Strobel, Jena (DE); Jens Marzinkowski, Jena (DE); Hans-Juergen Schmidt, Jena (DE); Hans-Juergen Mueller, Gera (DE)

Correspondence Address: Striker, Striker & Stenby, 103 East Neck Road, Huntington, NY, 11743, US

(21) Appl. No.: 12/647,200

(22) Filed: Dec. 24, 2009

(30) Foreign Application Priority Data
Dec. 29, 2008 (DE) 10 2008 063 299.6

(51) Int. Cl. C03C 3/04; C03B 37/00; C03B 37/014

(52) U.S. Cl. 501/53; 65/32.4; 65/157

(57) ABSTRACT

The process of making synthetic silica glass occurs in a combustion chamber of a muffle furnace. It includes producing a gas flow containing a fuel, an oxidizer, and a silicon compound that is converted by flame hydrolysis and/or by chemical oxidation to SiO₂ particles, and depositing them on a target to form a roll-shaped silica glass body. The combustion chamber is provided with a gas inlet and a gas outlet arranged at opposite ends of the combustion chamber, which widens from the inlet to the outlet. The gas flow is produced by a central nozzle for the silicon compound, a first concentric ring-shaped nozzle for the oxidizer, and a second concentric ring-shaped nozzle for the fuel. The process is characterized by a ratio of areas of ring gaps of the ring-shaped nozzles of from 1:4 to 1:6.1. The apparatus for the process is also part of the invention.

### CROSS-REFERENCE

The invention described and claimed herein below is also described in German Patent Application 10 2008 063 299.6, which was filed on Dec. 29, 2008 in Germany. The aforesaid German Patent Application provides the basis for a claim of priority of invention for the invention described and claimed herein below under 35 U.S.C. 119 (a) to (d).

### BACKGROUND OF THE INVENTION

1. The Field of the Invention

The present invention relates to a process of making a dense synthetic silica glass, a muffle furnace for performing the process, and silica glass obtained from the process.

2. The Description of the Related Art

Silica glass is a transparent glass, which exclusively consists of SiO₂. Silica glass has been known for many years and is versatile because of its great resistance to chemical attack, its high temperature stability, and its good transmittance for infrared to ultraviolet radiation, i.e. for light having wavelengths from about 3500 nm to 160 nm. Silica glass plays a special role as window and lens material for optical elements, which transmit ultraviolet radiation, for example of an excimer laser and in photolithography. Fiber optic cable, with which laser beams and also news and information can be transmitted, is another important application for silica glass. However it has been shown that especially pure silica glass often has an absorption band of 2500 to 3000 nm, and a laser-induced fluorescence caused by the so-called intrinsic defects (e.g. among other also ODC), which cause absorption, especially at a wavelength of 651 nm. Thus many attempts have been made to improve the quality of silica glass.

In order to alleviate the aforesaid disadvantages for example synthetic silica glass has been made with a special high quality for special applications. Customarily a gaseous silicon halide is burned with oxyhydrogen gas in a combustion chamber and converted by flame hydrolysis to SiO₂, which then condenses in fine droplets, which are deposited on a target by thermophoresis. In this way a primarily rod-shaped or roll-shaped synthetic silica glass body is gradually produced.

The mixture produced by flame hydrolysis is usually conveyed by the total flow of gas from different nozzles, wherein the gaseous silicon halide together with a carrier gas is conducted through a central nozzle into the combustion chamber of a muffle furnace. Concentric ring-shaped fuel and oxidizer nozzles, which alternately surround this central nozzle through which the reactant material is supplied, are arranged around this central nozzle. In this way a more or less laminar gas flow at least up to the target or the target surface, on which the SiO₂ droplets are deposited, is produced. The deposition of the SiO₂ droplets on the target surface usually occurs by thermophoresis. Many attempts have been made in the art to try to improve this process.

For example, WO 98/40319 describes an apparatus for making a preform of synthetic silica glass, wherein a muffle furnace with a horizontal combustion chamber has two opposing different-sized openings, of which the larger serves for removal of the preform and the smaller for insertion of a burner nozzle. The muffle furnace interior chamber or combustion chamber expands in a direction from the smaller opening to the larger opening. The entire length of the muffle furnace amounts to twice the diameter of the preform made from synthetic silica or quartz glass.

DE-A 42 03 287 describes a process and an apparatus for making a synthetic silica glass, in which the SiO₂ target surface on which the growing silica body resides is maintained at a constant distance from the burner nozzle with the aid of optoelectronic means. In that means a pulsed light beam is propagated so that its beam axis is tangent to the deposition surface. If the light beam is interrupted by the growing deposited silica glass, then the forming silica glass body is drawn further away from the burner nozzle by a drawing device until the pulsed light beam again passes by the surface on which the silica is being deposited by the process.

WO 2004/065314 A describes a similar process for making synthetic silica glass, in which a mixture of a single monomeric silicon compound containing a single silicon atom and an oligomeric silicon compound containing several silicon atoms is used as a raw material or reactant. However the oligomeric silicon compound may be contained in the mixture in amounts up to 70%.

JP-A 2006-016292 describes a burner for making synthetic silica glass, in which an outer ring-shaped nozzle is arranged around a central nozzle for supplying the reactant mixture and around the concentrically arranged ring-shaped burner nozzles. A gas with a low reactivity that forms a jacket or sheath around the reactant and combustion gases and thus shields them from outside influences is supplied through the outer ring-shaped nozzle.

All these processes of the prior art require a high burner capacity in order to hydrolyze the expensive silicon precursor or reactant and to deposit the silica. However it has been shown that a comparatively high fraction of so-called infiltrated or secondary air, so-called “false air”, is introduced in these processes, whereby not only is there an energy loss, but also incomplete and unsatisfactory flame hydrolysis of the silicon compound to SiO₂ occurs. Typically only from 60 to 75% of the silicon reactant compound is deposited as silica on the respective target using these processes and techniques of the prior art.

### SUMMARY OF THE INVENTION

Accordingly it is an object of the present invention to lower the energy loss in the conversion of the silicon reactant compound to the deposited silica and to increase the yield of the silica.

It is another object of the present invention to provide a silica or quartz glass with an improved more uniform radial index of refraction distribution, a higher transmission, and a reduced laser-induced fluorescence (LIF), especially in a wavelength range around 651 nm.

This object is attained by the features of the process and apparatus according to the appended claims.

The claimed process increases the yield and quality of the synthetic silica glass when the nozzle openings of the ring-shaped fuel and oxidizer nozzles around the central reactant nozzle are adjusted so that a gap ratio between the second and the third nozzles is at least 3.8, and especially at least 4. However gap ratios of at least 4.2 and especially at least 4.4 are especially preferred. The maximum gap ratio amounts to 5.6, especially 5.4, but 5.2 is preferred for the maximum gap ratio. Furthermore a gap ratio of at most 5.0 is especially preferred. The gap ratio between the first and the second nozzles amounts to at least 6.0, preferably at least 6.2, but at least 6.4 is especially preferred. The maximum value amounts to preferably 8.2 and especially 7.5, but a maximum value of 7.0 is particularly preferred.

It has been shown that the adjustment of the gap ratio and/or the nozzle cross-sectional areas and especially adjustment of the ratio of the volume flow rates of SiO₂, dry oxygen, and fuel gas, especially H₂ and O₂, can greatly reduce or completely eliminate the formation of undesirable red fluorescence.

The cross-sectional area for the first ring-shaped nozzle for oxygen around the central reactant nozzle is preferably at least 6 mm², especially 6.8 mm² or 7 mm², wherein at least 7.1 mm² or 7.2 mm² is especially preferred. Maximum cross-sectional areas amount to 9 mm², especially 8.8 mm², but a maximum value of 8.5 or 8.3 mm² is particularly preferred. Maximum values of 8 or 7.8 mm² are most preferred. The preferred cross-sectional area for the ring-shaped nozzle (second combustion nozzle) supplying hydrogen amounts to at least 115 mm², but 120 mm² is especially preferred. A value of at least 122 mm² is most preferred. Preferred maximum values amount to 135 mm², especially 130, mm², but a maximum value of 128 mm² is most preferred. Preferred values for the cross-sectional area of the third ring-shaped nozzle (oxygen nozzle) amounts to at least 35 mm², wherein values of at least 38 mm² and/or 40 mm² are especially preferred. Preferred maximum cross-sectional areas amount to 50 mm², especially 45, mm², but 43 mm² is especially preferred as a maximum cross-sectional area. Preferred cross-sectional areas for the fourth ring-shaped nozzle (hydrogen fuel nozzle) are at least 150 mm², especially at least 160, mm², but at least 162 mm² is especially preferred. Typical maximum cross-sectional areas amount to 180 or 170 mm², but 168 mm² is especially preferred. According to the invention it has been shown that the gap ratio of the third oxygen ring-shaped nozzle to the fourth hydrogen ring-shaped nozzle is preferably at least 4.6, especially at least 4.7, but at least 4.8 is especially preferred. Preferred maximum ratios amount to 5.6, especially 5.2, but a maximum ratio of 5.1 is particularly preferred.

In a preferred embodiment the volume flow rates of both nozzles can be described by the mixture ratios:

MV interior: H2−2/(O2tr+O2−1+O2−3/2)
MV practice: (H2−2/2+H2−4/2)/O2−3,
wherein tr is the dry oxygen of the central reactant nozzle. The mixture ratio can be varied over a wide range according to the required OH content. The range is from 1.7 to 2.5, but preferably is from 1.9-2.3.

However the volume flow rate of hydrogen is determined by the total output of the burner and cannot be arbitrarily lowered. Thus volume flow rates for H2-2 are in a range of from 130 to 90 slm (standard liter per minute), preferably 120 to 105 slm. Volume flow rates of 70 to 35 slm, preferably 65 to 40 slm, are used for O2-3.

Preferably the oxidizing agent and also the fuel gas are conducted into the combustion chamber with different outlet speeds than are used with the central reactant nozzle.

In a preferred embodiment both inner combustion gas and oxidizing agent nozzles are arranged around additional alternating fuel and oxidizer gas nozzles. Customarily the four inner fuel gas and oxidizing agent gas nozzles are designated as in the inner nozzle region and the four outer fuel gas and oxidizing agent gas nozzles are designated as in the outer nozzle region, in order to distinguish the inner gas nozzles from the outer gas nozzles. In a preferred embodiment the outer region includes at least two, especially at least four or five nozzles. Principally the maximum number of nozzles is not limited, but maximum values of at most seven, especially at most six, outer nozzles have proven to be completely sufficient. Preferably the maximum number of outer nozzles amounts to five, especially four, outer nozzles.

In an additional preferred embodiment the outer nozzles are surrounded by still more outer ring-shaped nozzles, which supply an inert or only weakly reactive sheathing gas in order to surround the reaction gas.

Since the infiltrated or secondary air may not be completely avoided, in another preferred embodiment the infiltrated or secondary air that is introduced is preheated in this system. Temperatures of the infiltrated or secondary air of at least 90° C., especially at least 100° C., have proven to be suitable, but temperatures of 120° C. or 140° C. are preferred. Temperatures of at least 150° C. are especially preferred. Suitable maximum temperatures are 300° C. or 280° C., but maximum temperatures of 260° C. or 250° C. are especially preferred. Preferably the entire outer secondary air and likewise the sheathing gas are heated.

It was found that the objects of the invention could also be attained independent of the aforesaid features and steps when the combustion chamber or its muffle furnace housing is extended, and indeed so that it houses or extends beyond the target surface of the target or the already forming silica glass body or the tip of that body by at least 200 mm, especially at least 220 mm, and preferably at least 240 mm. The muffle furnace housing especially preferably extends about at least 250 mm or 260 mm beyond the target surface on which the silica is deposited.

In an additional preferred embodiment the lower part of the muffle furnace extends out beyond the upper part and indeed has a length that is 1.1 times, preferably at least 1.5 times that of the upper part, but at least 1.2 times is particularly preferred. A so-called “half-open combustion chamber” system is formed.

Moreover it has proven to be appropriate that the end or the edge of the lower part of the muffle furnace housing is closed by a half ring-shaped barrier or wall. The closure should have a ratio to the diameter of the silica glass roll of at least 1:1.1, preferably 1:1.2±0.5 and at most 1:1.8.

It has proven to be appropriate that the exhaust gas from the process together with the SiO₂ particles or droplets that were not deposited, and the infiltrated or secondary air are removed by means of evacuation or suction. Preferably the evacuation occurs at a point after which the desired deposition of the SiO₂ droplets has already occurred on the growing silica glass body. Typically the evacuation starts at a point, at which the muffle furnace housing ends, i.e. at least 200 mm after the deposition front or surface on the target for the silica glass body. That means that the evacuation or suction is then typically performed when the exhaust gas flow leaves the muffle furnace housing. In a preferred embodiment at least 90% of the path of the gas flow from the burner nozzle to the exhaust is accommodated within the housing. At least 95% and especially at least 98% of the path is preferably accommodated within the housing.

The evacuation or exhaust itself is chiefly due to thermal convection. In a suitable embodiment however the evacuation or suction occurs by the production of a slight low pressure of at least 2 mbar and especially at least 3 mbar. However a low pressure of at least 4 or 5 mbar is preferred. The maximum suitable low pressure amounts to 250 mbar, but a maximum lower pressure of 200 mbar, especially 150 mbar, has proven to be suitable. In many cases a lower pressure of at most 100 mbar, at most 80 mbar, at most 70 mbar, and especially at most 50 mbar, has proven to be completely sufficient.

Furthermore it has proven to be appropriate when the inner diameter of the muffle housing is selected so that a ratio of the diameter of the silica blank that is produced by the process to the inner diameter of the muffle housing at its widest point is at least 1:1.2 and especially at least 1:1.3. However a minimum value of the ratio is preferably 1:1.5 or 1:1.7. Suitable maximum values of the ratio amount to 1:2.8, especially 1:2.5, but a maximum value of 1:2.4 or 1:2.3 is especially preferred. An optimum value of the ratio of the diameter of the silica blank to the inner diameter of the muffle furnace or the combustion chamber is 1:2±0.1. In order to produce a flow that is as laminar as possible it has proven to be suitable to select the shape of the cross-section of the muffle furnace so that it is arc-shaped in a direction toward the rear. The arc-shaped widening of the cross-section of the muffle furnace can be parabolic, oval or circular.

According to the invention it is possible to use all the known silicon compounds. However the silicon halides are especially preferred silicon compounds for use in the process according to the invention. Silicon chlorides are especially preferred. Silicon chlorides of formula SiₙCl₂ₙ₊₂ in which n is 1 to 5, preferably 1 to 3, are particularly preferred. Oxygen is an especially preferred oxidizing agent. Air or air enriched with oxygen can be used as oxidizing agent. All known fuels can be used as the fuel. However it has proven to be especially suitable when hydrogen is used as the fuel.

In a further preferred embodiment the muffle furnace according to the invention or the process according to the invention has an optoelectronic device, which detects the growth of the silica blank forming on the target surface of the target by deposition of SiO₂ particles and according to the increased thickness of the silica body sends a control signal to an adjusting motor, which moves the roll-shaped silica glass body out from the combustion chamber by a distance equal or about equal to the increased thickness resulting from the growth. A typical optoelectronic device for this purpose is a light barrier device or photoelectric guard device, which in an especially preferred embodiment is pulsed.

It has been shown that the production efficiency of the process according to the invention is greatly increased in relation to the prior art processes. In other words, the process according to the invention has a higher deposition rate with reduced fuel consumption than the prior art processes. The procedure according to the invention has reduced energy consumption. The conventional procedure consumes 80 m³ of hydrogen per kg of silica glass, but the procedure according to the invention reduces the energy consumption below 60 m³ of hydrogen per kg of silica glass, especially under 50 m³ of hydrogen per kg of silica glass.

In the procedure according to the invention the reactive silicon compound is conducted with a carrier gas, usually oxygen, into the central reactant nozzle. The ratio of the volume flow rate of silicon halide to that of dry carrier oxygen is preferably at least 1:12, especially at least 1:14, however a ratio of at least 1:15, especially at least 1:16, is particularly preferred. It has been shown that maximum values of the ratio of at most 1:30, especially at most 1:28, have proven to be suitable. However a maximum value of 1:26 or 1:25 is preferable. The volume flow rates defined as standard liter per minute are measured with a mass flow control at constant vapor pressure of SiCl₄. The volume flow rates are metered or measured by mass flow control independently of the pressure fluctuations of the vaporizing unit.

The process according to the invention may run both horizontally and also vertically. In other words, the axis of the silica glass cylinder or the longitudinal axis of the combustion chamber may extend horizontally or vertically. The vertical embodiment of the process may proceed both in the direction of gravity or opposite thereto. Typical roll or cylinder size for the horizontal process is from 90 to 200 mm and for the vertical process, 130 to 250 mm.

The invention also includes an apparatus for performing the process according to the invention. This sort of apparatus has the aforesaid definite gap or outlet surface ratios and/or the aforesaid definite extension of the combustion chamber or housing.

According to the invention it was found that an especially good silica glass with a radial refractive index distribution PV (peak-to-valley) of less than 5×10⁻⁶ with a good transmission of greater than 99.4% per centimeter may be produced. Furthermore the good silica glass has a very weak fluorescence in a wavelength range between 550 and 810 nm, especially at 651 nm, especially with excitation by light with a wavelength between 300 or 350 nm and 700 nm. The glass according to the invention is characterized above all by an exceptionally good ratio of the laser-induced fluorescence peak intensities at 430 and 650 nm. This ratio is preferably 1:1.3, preferably at maximum of 1:1.25, but a maximum value of 1:1.2 is especially preferred. Typical values amount to less than 1:1.8, especially 1:1.17.

It has been shown that the formation of red fluorescence is especially reduced by the features, of the invention, especially by the changed structure of the muffle furnace and/or especially by the adjustment of the gap and/or volume flow ratios of the central ring-shaped nozzles.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is diagrammatic plan view showing the structure of the ring-shaped burner nozzles in the burner that is used to perform the process of the invention;

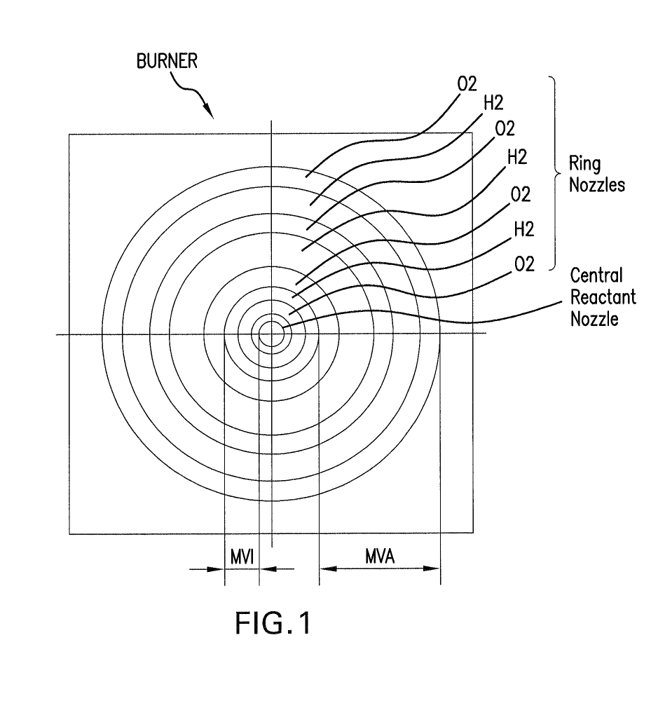

FIG. 2 is a diagrammatic longitudinal cross-sectional view through a silica glass body obtained with the process according to the present invention;

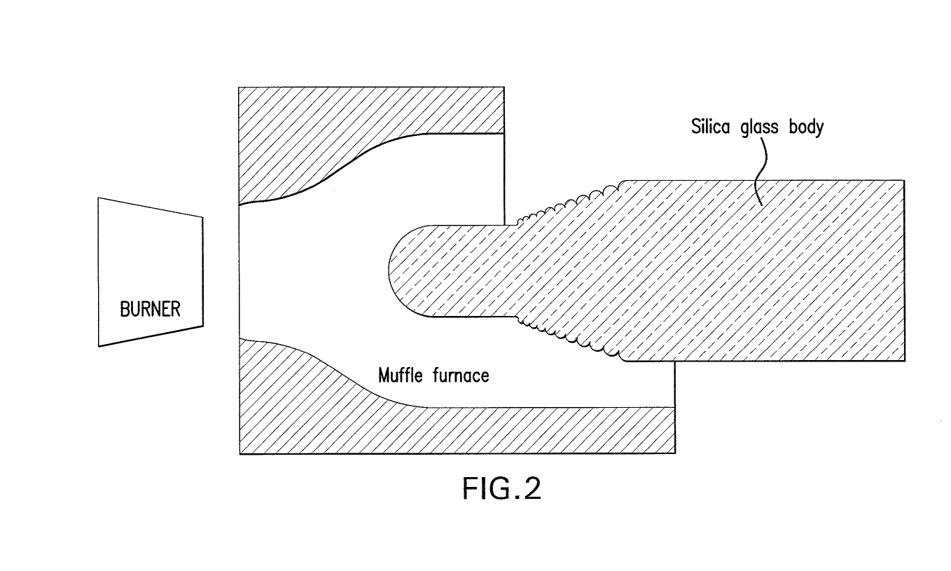

FIG. 3 is a graphical illustration showing the increase in the product production rate obtained by adjusting gap and surface area ratios of the two inner ring-shaped nozzles in the process according to the invention;

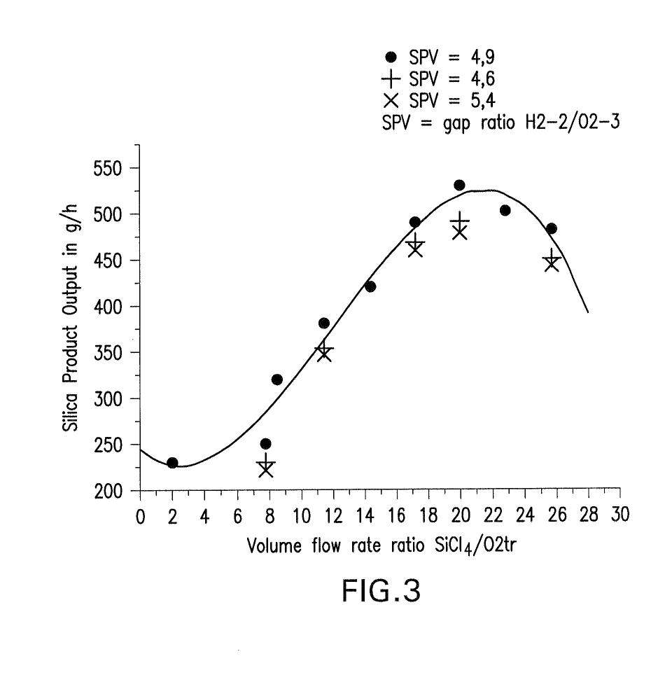

FIG. 4 is a graphical comparison of the laser-induced fluorescence spectra of a conventional silica glass and a silica glass obtained by the process of the invention; and

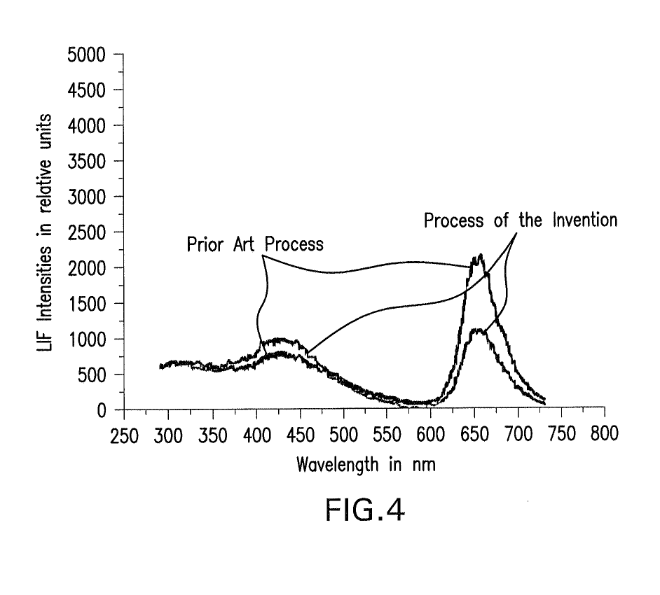

FIG. 5 is a graphical illustration showing the relative decrease in the fluorescence signal at a wavelength of 651 nm caused by reducing the fraction of oxygen carrier gas conducted through the central reactant nozzle.

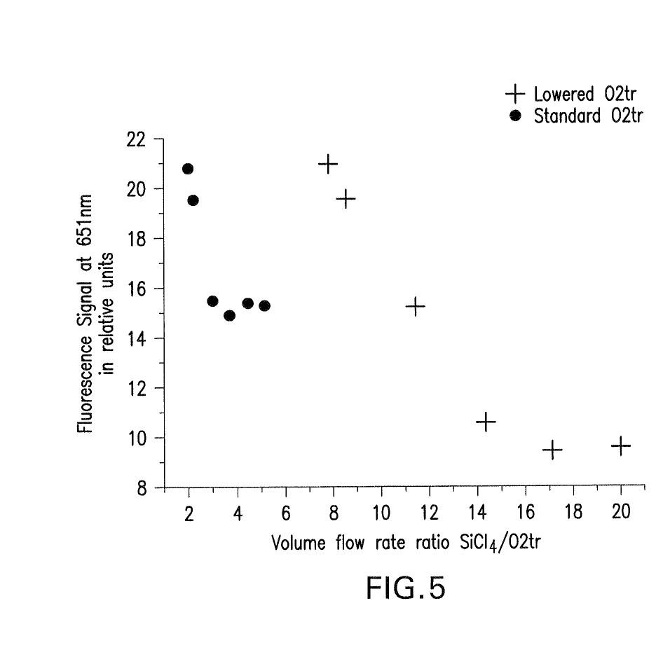

### DESCRIPTION OF PREFERRED EMBODIMENTS

### Examples

A silica glass roll with a diameter of 147 mm and a weight of 46 kg was produced with an 8 nozzle burner and standard muffle furnace with an SiCl₄ flow rate of 2.75 slm (standard liter per minute), which corresponds to a ratio of halide volume flow rate to oxygen carrier flow rate of 2.03, with a total hydrogen volume flow rate of 355 slm in 198 hours. The production rate was 256 g/h. The gap ratio of the burner amounted to 5.32. The required amount of hydrogen per kilogram of silica glass product amounted to 83.5 m³/kg.

An increase of production rate to 287 g/h could be achieved by the conversion process according to the invention in a muffle apparatus with production parameters that were otherwise the same. The energy efficiency was improved, which is evident because of the reduced required amount of hydrogen, namely 79.4 m³ of hydrogen per kilogram of silica glass product.

The adjustment of the gap area of the second and third ring-shaped nozzle led to a gap ratio of 4.9. The product roll with a similar roll diameter had a product production rate of 302 g/h.

The increase of the ratio of dry oxygen flow rate of 2 to 12 and then to 22 led to a lowering of the production time from 198 h to 140 h and then to 127 h and thus to a lowering of the hydrogen consumption per kg of good glass of 83.5 m³/kg to 62.3 m³/kg and then to 48.8 m³/kg. The product production rate increased to 380 g/h and then to 510 g/h.

The increase of the volume flow rate ratio of SiCl₄ to dry oxygen connected with the adjustment of the gap ratio of oxidizer and fuel leads to a definite lowering of the laser-induced fluorescence, especially in the vicinity of 651 nm.

Table I herein below shows the dependence of the silica glass production rate and energy efficiency on the process parameters of four examples of the process according to the invention.

TABLE I
SILICA GLASS PRODUCTION RATE AND ENERGY
EFFICIENCY AS A FUNCTION OF PARAMETERS
OF THE PROCESS OF THE INVENTION

| | | | | H₂ con- | |
|---|---|---|---|---|---|
| | | | Glass | sumption, | Roll |
| Example | Gap | VSiCl₄/VO₂tr, | Production | m³/kg of | Diameter, |
| No. | ratio | slm/slm | Rate, g/h | silica glass | mm |
| 1 | 5.3 | 2.03 | 256 | 83.5 | 147 |
| 2 | 4.9 | 2.03 | 302 | 79.4 | 151 |
| 3 | 4.9 | 12 | 380 | 62.3 | 148 |
| 4 | 4.9 | 22 | 510 | 48.8 | 152 |

Table II herein below shows the dependence of the laser-induced fluorescence intensities at 651 nm on the same process parameters for the same four examples of the process according to the invention as in Table I.

TABLE II
LASER-INDUCED FLUORESCENE INTENSITY AS A FUNCTION
OF PARAMETERS OF THE PROCESS OF THE INVENTION

| | | | Peak Height of Laser- | Roll |
|---|---|---|---|---|
| Example | Gap | VSiCl₄/VO₂tr., | Induced Fluorescence | Diameter, |
| No. | ratio | slm/slm | at 651 nm, a.u. | mm |
| 1 | 5.3 | 2.03 | 22.4 | 147 |
| 2 | 4.9 | 2.03 | 21.6 | 151 |
| 3 | 4.9 | 12 | 15.8 | 148 |
| 4 | 4.9 | 22 | 9.2 | 152 |

While the invention has been illustrated and described as embodied in a process of making a dense synthetic silica glass, a muffle furnace for performing the process, and silica glass obtained from the process, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A process of making synthetic silica glass in a combustion chamber of a muffle furnace, said process comprising the steps of:
a) producing a gas flow in the combustion chamber, said gas flow containing a fuel, a chemical oxidizing agent, and a gaseous silicon compound, which is converted by flame hydrolysis and/or by chemical oxidation to SiO₂ particles; and
b) depositing the SiO₂ particles on a target surface of a target in the combustion chamber so as to form a roll-shaped silica glass body;
wherein the combustion chamber is bounded by chamber walls and has a front end provided with a gas inlet and a rear end provided with a gas outlet, and said chamber walls and said outlets are arranged rotationally symmetric in relation to a longitudinal axis of the combustion chamber and said combustion chamber widens in a direction from the gas inlet to the gas outlet;
wherein the gas flow is produced by at least three nozzles, said three nozzles comprising a central nozzle for supplying the silicon compound arranged at said front end of the combustion chamber, a first ring-shaped nozzle for supplying the oxidizing agent arranged concentric to and spaced from said central nozzle, and a second ring-shaped nozzle arranged concentric to the central nozzle, which has a diameter that is greater than a diameter of the first ring-shaped nozzle;
wherein the first ring-shaped nozzle has a first ring gap and the second ring-shaped nozzle has a second ring gap and a ratio of an area of the second ring gap to an area of the first ring gap is from 1:4 to 1:6.1.

2. The process as recited in claim 1, wherein SiCl₄ is supplied from the central nozzle together with dry oxygen as carrier gas.

3. The process as recited in claim 1, further comprising removing consumed gases.

4. The process as recited in claim 3, wherein the consumed gases are removed by evacuation or suction at a pressure of 3 to 250 mbar.

5. The process as recited in claim 1, wherein at least 99% of the space for the nozzles and suction are accommodated by the walls of the muffle furnace.

6. The process as recited in claim 1, wherein the target surface of the target has a temperature of at least 1600° C. during the depositing.

7. The process as recited in claim 1, further comprising feeding the chemical oxidizing agent and the fuel into the combustion chamber through at least four concentrically arranged alternating ring nozzles arranged around said central nozzle.

8. The process as recited in claim 1, wherein the combustion chamber has a housing that extends at least 200 mm beyond the target surface of the target.

9. A muffle furnace for making synthetic silica glass, said muffle furnace comprising
a combustion chamber housed within muffle furnace walls, which has a longitudinal axis and is provided with a front gas inlet opening and a rear gas outlet opening, wherein said walls, said inlet opening, and said outlet opening are arranged rotationally symmetrically in relation to said longitudinal axis and said combustion chamber widens in a direction from the gas inlet opening to the gas outlet opening;
a central nozzle for supplying a gaseous silicon compound, said central nozzle being arranged in the vicinity of the front inlet opening on said longitudinal axis;
a first ring-shaped nozzle for supplying an oxidizing agent arranged concentric to and spaced from said central nozzle; and
a second ring-shaped nozzle arranged similarly concentric to the central nozzle, which has a diameter that is greater than a diameter of the first ring-shaped nozzle;
wherein the first ring-shaped nozzle has a first ring gap and the second ring-shaped nozzle has a second ring gap and a ratio of an area of the second ring gap to an area of the first ring gap is from 1:4 to 1:6.1.

10. The muffle furnace as recited in claim 9, further comprising an optoelectronic device that detects growth of a roll-shaped silica glass body produced by deposition of SiO₂ particles on a target surface in the combustion chamber and controls an adjusting motor, which moves the silica glass body out from the combustion chamber by a distance about equal to a length that the silica glass body has grown.

11. The muffle furnace as recited in claim 10, having a maximum diameter such that a ratio of the maximum diameter to a diameter of the silica glass body is from 1.3:1 to 2.5:1.

12. The muffle furnace as recited in claim 9, wherein the combustion chamber has a housing that extends at least 200 mm beyond the optoelectronic device.

13. The muffle furnace as recited in claim 12, wherein the housing has a lower part and an upper part and the lower part extends out from the upper part by a distance equal to at least 1.1 times a length of the upper part along the longitudinal axis.

14. The muffle furnace as recited in claim 13, wherein one end of the lower part of the housing has a half ring-shaped closure for closing an interior of the combustion chamber.

15. A synthetic silica glass obtained by the process recited in claim 1.
